(19) United States
(12) Patent Application Publication
(10) Pub. No.: US 2025/0363376 A1
(43) Pub. Date: Nov. 27, 2025

(54) TRAINING A DUAL ENCODER WITH A CORRECTION MODEL

(71) Applicant: GDM Holding LLC, Mountain View, CA (US)

(72) Inventors: Nicholas Brady Garvan Monath, Cambridge, MA (US); Will S. Grathwohl, New York, NY (US); Michael James Boratko, West Hartford, CT (US); Robert David Fergus, New York, NY (US); Andrew Kachites McCallum, Amherst, MA (US); Manzil Zaheer, Mountain View, CA (US)

(21) Appl. No.: 19/041,535

(22) Filed: Jan. 30, 2025

Related U.S. Application Data
(60) Provisional application No. 63/548,834, filed on Feb. 1, 2024.

(51) Int. Cl. G06N 3/09; G06N 3/045; G06N 3/048

(52) U.S. Cl. CPC G06N 3/09; G06N 3/045; G06N 3/048

(57) ABSTRACT

Methods, systems, and apparatus, including computer programs encoded on a computer storage medium, for that can train a dual encoder model using a correction model to correct target embeddings at each training iteration without explicitly recalculating each target embedding. In one aspect, a system comprises obtaining approximated target embeddings for a plurality of target data items, processing the respective approximated target embeddings using a correction model to generate corrected target embeddings, processing a query data item using a query encoder model to generate a query embedding, electing, using the corrected target embeddings and the query embedding, a subset of the target data items as relevant target data items, and training the dual encoder model on a loss function for the retrieval task using the relevant target data items for the one or more query data items.

### CLAIM OF PRIORITY

This application claims priority under 35 USC § 119(e) to U.S. Patent Application Ser. No. 63/548,834, filed on Feb. 1, 2024, the entire contents of which are hereby incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can train a dual encoder model using a correction model to correct target embeddings at each training iteration without explicitly recalculating, e.g., regenerating, each target embedding at every training iteration.

In this specification, a dual encoder model is a neural encoder model that includes a query encoder model to generate a representation of an input query data item in a query embedding space and a target encoder model to generate a representation of a target data item, e.g., a document, image, video, etc., in a target embedding space. The dual encoder model can produce an output by computing measures of similarity between the query embedding of the query data item and the target embeddings of the target data items, e.g., to identify a particular target data item or the top k most similar target data items based on the measures of similarity.

In particular, the dual encoder model can be used for a retrieval task, e.g., retrieval of specific target data item(s) as relevant to the input query data item. As an example, the specific target data item can be a document that includes content pertaining to the answer to the query posed by the query data item. In some cases, the dual encoder can be used to retrieve context documents that can be processed along with the query as an input to a generative machine learning model, e.g., a large language model or a vision-language model, to generate a response to the query.

In this specification, correcting target embeddings refers to correcting the approximated target embeddings, e.g., the stale target embeddings generated at a previous training iteration, to compensate for accuracy drift, e.g., generating a less accurate measure of similarity to predict the target data items as a result of training with cached embeddings. More specifically, the system can jointly train the dual encoder and a correction model such that the correction model can learn to predict a corrected target embedding for each of the target data items, e.g., a corrected embedding that accounts for the drift from the approximated target embedding, e.g., the stale embeddings, at each training iteration.

According to a first aspect there is provided a method for training a dual encoder model comprising a query encoder model and a target encoder model to perform a retrieval task, the method comprising, at each of a plurality of training steps: obtaining a respective approximated target embedding for each of a plurality of target data items, for each target data item, processing the respective approximated target embedding of the target data item using a correction model to generate a corrected target embedding of the target data item, receiving one or more query data items, for each query data item, processing the query data item using the query encoder model to generate a query embedding of the query data item, selecting, using the corrected target embeddings of the target data items and the query embedding of the query data item, a subset of the target data items as relevant target data items, and training the dual encoder model on a loss function for the retrieval task using the relevant target data items for the one or more query data items.

Particular embodiments of the subject matter described in this specification can be implemented so as to realize one or more of the following advantages.

Training a dual encoder model can be computationally challenging, since exhaustively re-encoding target embeddings for every target data item in the set of target data items at each training iteration requires an impractical use of computational resources. In particular, it is intractable to generate respective embeddings for each of the target data items at every training iteration in dual encoder models with complicated neural network architectures. Moreover, for large datasets (e.g., the CommonCrawl Corpus) it would not presently be feasible to recalculate precise target embeddings for each of the target data items in each training iteration, because exhaustively re-encoding the number of target embeddings can be intractable given the constraints of existing hardware. That is, in some cases, the total available memory and compute of the computer system is insufficient to perform a forward pass through the target encoder model at each training step for all target data items. In particular, re-encoding every target data item at each training iteration can require an impractically high latency and data throughput.

For example, in the case that the dual encoder model is implemented with tens to hundreds of millions of parameters, it is computationally prohibitive to recalculate every target embedding via a forward pass at each training iteration. Some training systems subvert the need to re-generate the target embeddings for every target data item by caching the target embeddings and maintaining them, e.g., in a database, for use in additional training iterations. However, it is generally not prudent to rely on cached target embeddings, since using stale embeddings can result in less accurate outputs due to accuracy drift of the target embeddings that are used to determine the output.

In contrast, the techniques of this specification can provide for training a dual encoder model using corrected target embeddings at each training iteration, while reducing the use of computational resources required to generate the corrected target embeddings. More specifically, the system of this specification can correct for drift, as opposed to exhaustively (and impractically) re-encoding every target data item in the set of target data items using the target encoder model at each training iteration. In particular, correcting for drift can result in target embeddings with comparable accuracy to target embeddings produced by exhaustively re-encoding the target data items during training, while using a fraction of the computational resources required to recalculate the target embeddings directly.

Given the constraints of existing hardware, the training technique of this specification has been designed such that no additional computation of the precise target embeddings is required over existing methods (e.g., stale buffer training). In particular, the system can process the approximated target embeddings, e.g., from a buffer, using the correction model at each training iteration to correct for drift in the approximation. By generating corrected target embeddings from the approximated target embeddings in the buffer using the correction model, the method is adapted for execution on currently available hardware accelerators, e.g., the training techniques of this specification can be performed by a computer system that distributes the training over a number of accelerators, e.g., GPUS, TPUS, etc.

In particular, as the capacity of device memory in the hardware being used to train the dual encoder model may also be limited, the method allows for the correction model to be relatively small in comparison to the dual encoder model and may therefore be stored in device memory during training of the dual encoder models. More specifically, using the correction model to correct for drift with minimal latency is feasible, e.g., since the correction model can have many fewer parameters than the target encoder model, and therefore can fit in memory to operate directly on the approximated embeddings to correct for drift.

Additionally, it has been found that providing and using the correction model on existing hardware adds relatively little computational overhead compared to prior methods e.g., relative to using some combination of stale and cached updated embeddings and stale embeddings, e.g., approximations using subsets of outcomes, rejection sampling, kernel-based methods, etc. While the buffer data including the approximated target embeddings may be large, generating a corrected target embedding using the correction model is considerably more efficient than calculating precise embeddings and can be performed using currently available hardware. Furthermore, the techniques of this specification can be implemented in the internal training loop since the inputs of the correction model, e.g., the approximated target embeddings for the relevant subset of target data items, and the ground truth for the correction model, e.g., the current embeddings for the relevant subset of target data items, are already calculated for the training of the dual encoder model, e.g., the training of the correction model does not require additional data generated with additional computational resources.

Moreover, the techniques of this specification can be implemented for training dense neural retrieval models, e.g., where the query and target encoders are large language models. Neural retrieval models are trained to retrieve relevant information, e.g., as specified by the query, from large datasets of target data items, e.g., thousands or hundreds of thousands of target data items. In this case, each target data item can be a document, image, video, etc. Large language models can have billions or hundreds of billions of parameters, and the drift using stale target embeddings generally increases with the number of parameters. The techniques of this specification can be used to efficiently mitigate this drift in target embeddings used for retrieval without requiring a forward pass of the target large language model for the thousands or hundreds of thousands of target data items in a training dataset.

Furthermore, the techniques of this specification are broadly applicable to approximating the softmax distribution efficiently and accurately for sampling from the distribution during dual encoder model training. In particular, the corrected target embeddings can be used to construct a softmax distribution for predicting target data items, while reducing computational resources, e.g., the computational expense of computing the actual softmax distribution is determined by how scalar unnormalized logits are computed, e.g., in the case of a dual encoder, from a forward pass of a large neural network. The techniques of the specification can be adapted for classification, reinforcement learning, or any other application in which a classification task is being performed in a large output space. Additionally, the techniques can be extended to align the embedding spaces of different sized models, e.g., a large dual encoder with a smaller model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example target embedding correction training system.

FIG. 2 illustrates how the system can correct stale target embeddings to be closer to the true target embeddings.

FIG. 3 demonstrates the effectiveness of the target embedding correction training system.

FIG. 4 is a flow diagram of an example process for using a correction model to train a dual encoder model.

Like reference numbers and designations in the various drawings indicate like elements.

### DETAILED DESCRIPTION

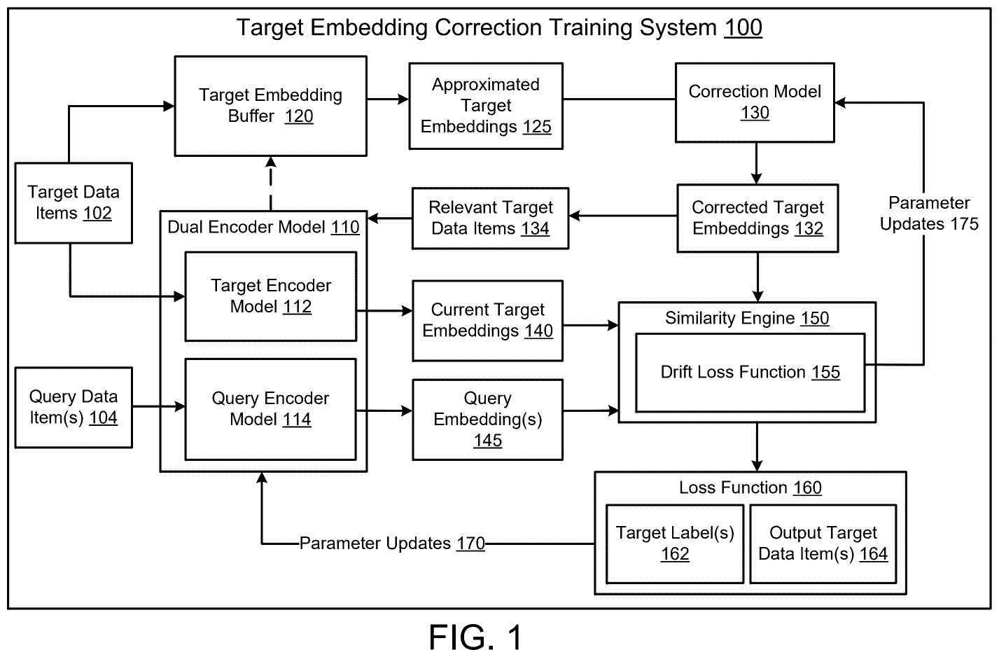

FIG. 1 shows an example target embedding correction training system 100. The target embedding correction training system 100 is an example of a system implemented as computer programs on one or more computers in one or more locations in which the systems, components, and techniques described below are implemented.

The system 100 can receive a training data set that includes target data items 102 and a set of query data item(s) 104. In particular, the target embedding correction training system 100 can be used to train a dual encoder model 110 to perform a retrieval task. More specifically, the dual encoder model 110 can be used to select one or more of the target data item(s) 102 as relevant for each respective query data item, as is described in more detail below.

For example, the query data item(s) 102 can include query inputs of one or more modalities, e.g., a text, image, video, or audio modality, and the target data items 104 can include one or more modalities, e.g., a text, image, video, or audio modality. In some cases, the target data items 102 are the same modality as the query data item(s) 104. In this case, the query data item(s) 102 and the target data items 104 can be image items, video items, text items, audio items, etc. As an example, the query data item can include an image and each of the target data items can include an image. As another example, the query data item can include a video and each of the target data items can include a video. In this case, the system 100 can use the dual encoder model 110 to identify one or more images or videos as relevant for the query data item.

In another case, the target data items 104 can be of a different modality than the query data item(s) 102. As an example, a query data item can include text and each of the target data items can be a document. In this case, the system 100 can use the dual encoder model 110 to identify one or more documents as relevant for the query data item. As another example, the query data item can include text and each of the target data items can be an image or video. In this case, the system 100 can use the dual encoder model 110 to identify one or more images or videos as relevant for the query data item. As yet another example, the query data item can include an image or a video and the target data items can be a document. In this case, the system 100 can use the dual encoder model 110 to identify one or more documents as relevant for the query data item.

In another case, one or more of the query 104 or target 102 data items can include multimodal data. For example, a query data item can include a captioned image and each of the target data items can be movie clips. In this case, the system 100 can use the dual encoder model 110 to identify one or more movie clips as relevant for the query data item. As another example, a query data item can include a podcast and each of the target data items can include audio data with associated lyrics. In this case, the system 100 can use the dual encoder model 110 to identify one or more audio data with associated lyrics as relevant for the query data item. As yet another example, a query data item can include a video with embedded event descriptors and each of the target data items can be images of objects with associated object descriptors. In this case, the system 100 can use the dual encoder model 110 to identify one or more images of objects with associated object descriptors as relevant for the query data item.

The dual encoder model 110 can include a target encoder model 112 and a query encoder model 114. The target encoder model 112 can be configured to process one or more target data item(s) 102 to generate target data item embeddings. The query encoder model 114 can be configured to process one or more query data item(s) to generate query embedding(s).

Both the target encoder 112 and the query encoder 114 models can have any appropriate machine learning architecture, e.g., a neural network, that can be configured to process an input, e.g., a query data item for the query encoder model 114 and a target data item for the target encoder model 112, and embed the input in the same embedding space. For instance, the target encoder model 112 and the query encoder model 114 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In some cases, the query encoder model 114 and the target encoder model 112 can be the same neural network. In particular, in the case that the query data item(s) 104 and the target data items 102 are the same modality, the system 100 can implement both the query encoder model 114 and the target encoder model 112 using the same encoder model, e.g., to process an input of the same type and embed the input of the same type in the same embedding space.

More specifically, the dual encoder model 110 can be implemented to embed the respective inputs in the same embedding space, such that the model 110 can compute a measure of similarity between the embedded query data item(s) and the embedded target data items, e.g., in order to perform a retrieval task, e.g., retrieval of one or more specific target data item(s) based on a query data item. For example, the measure of similarity that the dual encoder model 110 uses to select target data item(s) as an output can be an unnormalized logit, e.g., a vector of unnormalized values that represent the similarity scores between each of the target data items and each of the query data item(s).

In particular, the system 100 can perform a similarity comparison between target embeddings and the query embeddings for each of the query data item(s) 104, e.g., by computing an inner product using a dot product, a cosine similarity measure, or any other appropriate similarity measure, to generate an unnormalized logit value. The system 100 can then determine the target output for each query data item in the query data item(s) 104 by applying the softmax function over the unnormalized logit value:

$$P ( y \vert x ) = \frac{exp ( β {s}_{x , y} )}{{Z}_{x} {=}^{Δ} {\sum }_{{y}^{′} ∈ 𝒴} exp ( β {s}_{x , {y}^{′}} )} ,$$

where β is a tunable temperature parameter and s_{x,y} is the unnormalized similarity measure between query data item x and the y-th target data item.

In particular, the system 100 can sample from the softmax distribution, e.g., to randomly select an outcome according to the probabilities represented by the softmax distribution. More specifically, the softmax function yields a normalized probability distribution over the target data items 102, e.g., where all probabilities sum to one, by computing a normalizing constant Z. In this context, the output of the softmax function can be interpreted as the likelihood of each target data item being a correct match for a particular query data item x. Therefore, the output of the dual encoder model 110 can be obtained by computing an inner product of each respective query embedding for each of the query data item(s) 104 and each current approximated target embedding 125, to generate an unnormalized logit that can be used in a softmax calculation to predict the target output for the query data item.

In some cases, the dual encoder model 110 can be used to identify one or more target data item(s) that include the answer to the query data item. In this case, the trained dual encoder 110 can be used to retrieve target data items as context that can then be processed, along with the query data item, by a generative machine learning model to generate a response to the query. Moreover, in some cases, the dual encoder model 110 can be implemented using one or more language processing neural networks. For example, either or both of the target encoder model 112 and the query encoder model 114 can be implemented as large language models or vision-language models.

A language processing neural network is an auto-regressive network that is configured to sequentially process the contents of an input and trained to perform next element prediction, e.g., to define a likelihood score distribution over a next set of elements. In particular, the neural network can be referred to as an auto-regressive neural network when the neural network auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

For example, the neural network can be an auto-regressive Transformer-based neural network that includes (i) a plurality of attention blocks that each apply a self-attention operation and (ii) an output subnetwork that processes an output of the last attention block to generate the score distribution.

In this example, the neural network can have any of a variety of Transformer-based neural network architectures e.g., an encoder-decoder transformer, an encoder-only transformer, or a decoder-only transformer. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

More specifically, at each training iteration, the system 100 can process the query data item(s) 104, e.g., the query data item(s) 104 for the training iteration, using the query encoder model 114 to generate query embedding(s) 145. However, the system 100 does not process all of the target data items 102 using the target encoder model 112 to regenerate target embedding(s) at each training iteration, e.g., since it can be computationally difficult to exhaustively re-generate the target embeddings at every training iteration. In particular, in the case that the number of target data items 102 is sufficiently large, regenerating the target embeddings at every training iteration can be intractable based on the available hardware for training.

Instead, in the particular example depicted, the system 100 can maintain target embeddings generated in a previous training iteration in a target embedding buffer 120. As an example, the system 100 can regenerate the target embeddings for storage in the buffer 120 at a particular iteration or every N iterations, e.g., where N is 5, 10, or 20 training iterations. In this case, the system 100 can retrieve the approximated target embedding(s) 125 at each training iteration for use in selecting the target data items as the response for each query data item, e.g., by computing the inner product of each query data item in the query data item(s) 104 and each approximated target embedding 125, which can be used in a softmax calculation, as described above, to determine the one or more target data item(s) for each of the query data item(s) 104.

However, using the cached approximated target embedding(s) 125 for training the dual encoder model 110 can result in a dramatic decrease in the trained model performance, since relying upon stale embeddings, e.g., embeddings that were generated a number of iterations ago, can result in inaccurate target outputs in response to a query data item 104, thereby impacting the efficacy of the training process. If the softmax distribution is created with stale target embeddings, e.g., in the case that the current approximated target embedding(s) 125 have drifted from their actual values, the predicted target data items 134 can be unreliable, resulting in a less accurate measure of similarity as a result of training with cached embeddings. More specifically, approximating the softmax distribution efficiently and accurately is important when selecting a subset of target data items during dual encoder model 110 training as the selected target data items inform the calculation of the objective function used to update the parameters of the dual encoder model 110.

Instead of relying on the approximated target embedding(s) 125, the target embedding correction training system 100 can correct the target embeddings using a correction model 130 to preclude generating a less accurate measure of similarity between the target embedding. The correction model 130 can process each approximated target embedding in order to compensate for the accuracy drift of the target embedding during training. In this specification, correcting target embeddings refers to correcting approximated target embeddings, e.g., stale target embeddings that were generated at a previous training iteration and cached to prevent the need to regenerate each of the target embeddings at every training iteration.

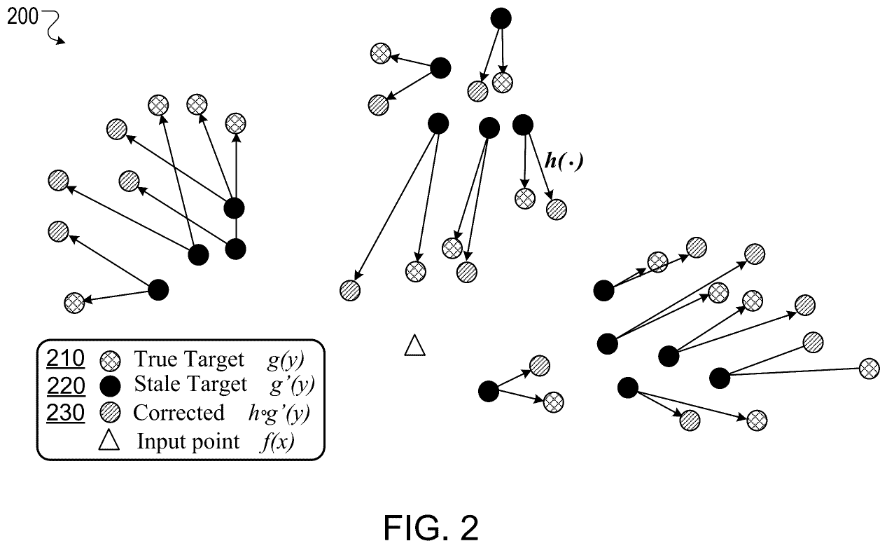

More specifically, the system 100 can employ a correction model 130 to account for the accuracy drift of target embeddings that occurs when approximated target embeddings are relied on during training, e.g., in the case that regenerating the target embeddings at each training iteration is intractable. In this specification, accuracy drift refers to the increasing discrepancy between stale cached target embeddings and the target embeddings that could be generated for the current training iteration, e.g., by exhaustively reprocessing each of the target data items 102 using the target encoder model 112 at every training iteration. An illustration of target embedding accuracy drift is depicted and described in more detail with respect to FIG. 2.

The correction model 130 can have any appropriate machine learning architecture, e.g., a neural network, that can be configured to process one or more approximated target embeddings 125 to generate one or more corresponding corrected target embeddings 132 based on a predicted measure of drift from the current respective approximated target embeddings. In particular, the correction model can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

For example, the system 100 can implement the correction model 130 as a small parametric neural network model, e.g., that has fewer parameters, a less complex architecture, or both relative to the dual encoder model 110, that can account for the discrepancy between each approximated target embedding 125 and a predicted “true” target embedding. In particular, the correction model 130 can correct the position of the approximated target embedding 125 in the shared embedding space of the dual encoder model 110. In some cases, the correction model 130 can generate a predicted drift vector, e.g., that can be combined with the approximated target embedding(s) 125 to generate the corrected target embedding(s) 132. In other case, the correction model 130 can generate the corrected target embedding(s) 132 directly by generating predicted corrected target embedding(s) 132 that account for the drift, e.g., as opposed to predicting the drift vector.

More specifically, the system 100 can use the correction model 130 to process a stale approximated target embedding for a target data item to generate a respective corrected target embedding for the target data item. The system 100 can then use the corrected target embedding(s) 132 to identify a subset of target data items as relevant target data items 134 for each query data item 104. In particular, the system 100 can select a subset of relevant target data items 134 from the corrected target embeddings 132 for each query data item using a measure of similarity.

More specifically, the system 100 can determine a measure of similarity between the corrected target embeddings 132 and the query embeddings 145, e.g., using the same measure of similarity that is implemented by the dual encoder model 110. In particular, the system can determine the measure of similarity by computing an inner product between the corrected target embeddings 132 and the query embeddings 145 to generate unnormalized similarity scores, e.g., unnormalized logits, for each of the target data items 102 with respect to each of the query data item(s) 104. The system 100 can then sample the subset of relevant target data items 134 for each query data item 104 based on the corrected target embeddings 132.

For example, the system 100 can use top-k sampling to select a subset of the k most probable target data items as the relevant target data items 134 for the query data item 104 according to the unnormalized similarity scores. As another example, the system 100 can use nucleus sampling to select a subset of target data items as the relevant target data items 134 based on a measure of cumulative probability mass for the selected subset of target data items exceeding a threshold measure of cumulative probability mass. As a related example, the system 100 can use Gumbel-Max sampling to apply a noise vector to the unnormalized similarity scores, e.g., the unnormalized logits, to generate a noisy unnormalized logit value as the similarity score, which can then be used to determine the measure of cumulative probability mass to select the subset of target data items as the relevant target data items 134. As yet another example, the system 100 can use Monte Carlo sampling to select multiple samples of relevant target data items and can average the results, e.g., by including the target data items that appeared in at least a threshold number of samples in the relevant target data items 134.

The system 100 can then update the target embeddings for each of the identified relevant target data items 134, e.g., by processing the subset of the target data items 102 that correspond with the relevant target data items 134 to generate current target embeddings 140 for the relevant target data items 134. The system 100 can additionally refresh a portion of the target embeddings stored in the target embedding buffer 120 at every training iteration. In particular, the system can correct the stale approximated target embeddings 125 using the correction model 130 to select a subset of relevant target data items 134, which can inform the regeneration of a subset of target embeddings as the current target embeddings 140. Thus, the target embeddings for the relevant target data items 134 are kept increasingly current relative to training with cached target embeddings.

Furthermore, the system 100 can rely on the respective subset of relevant target data items 134 to train the dual encoder model 110. In particular, the system 100 can use the current target embeddings 140 to generate the output 164 for each query data item 104, which can be compared to a target label 162 and used to train the dual encoder model 110.

More specifically, the system 100 can process the current target embeddings 140 and the respective query embedding(s) 145 for each query data item 104 using a similarity engine 150. The system 100 can use the similarity engine 150 to determine a measure of similarity between the current target embeddings 140 and the query embedding(s) 145, e.g., the measure of similarity can be the same measure of similarity that is implemented by the dual encoder model 110, in order to determine the subset of target data item(s) 164 as the output for each query data item.

In particular, the similarity engine 150 can select a particular target data item or the top k most similar target data items as the output target data item(s) 164 for each query data item 104. For example, the similarity engine 150 can select a particular target data item as the output target data item 164 by identifying the most similar corrected target embedding from the corrected target embeddings 140 with respect to the embedding of the query data item 145. As another example, the similarity engine 150 can select the top k most similar target data items as the output target data items 164 by identifying a subset of the k most similar corrected target embeddings 140 with respect to the embedding of the query data item 145.

In this case, rather than computing the actual softmax using updated current target embeddings for all of the target data item(s) 102, the system 100 can generate a truncated actual softmax based on the identified subset of relevant target data items 134 for each of the query data item(s) 104 that were used to generate updated current target embeddings 140. In particular, the system 100 can determine a respective measure of probability mass for each of the target data items 102 by computing an inner product between (i) the corrected target embeddings 140 for each relevant target data item 134 and the corrected target embeddings 132 for the remaining target data items, and (ii) each query embedding in the query embedding(s) 145 to generate an unnormalized logit value, which can be used in a softmax calculation to select the output target data item(s) 164 as the response for each of the query data item(s) 104.

The system 100 can train the dual encoder model 110 using a loss function 160 based on the discrepancy between the output target data item(s) 164 and the target label(s) 162 obtained for each of the query data item(s) 104, e.g., that each indicate the respective ground truth target data item(s) for each of the query data item(s) 104. For example, the discrepancy can be measured in any appropriate way, e.g., a mean-squared error loss or a cross-entropy loss. In particular, the system 100 can compute the parameter updates 170 for the dual encoder model 110 by calculating and backpropagating gradients of the loss function 160, e.g., using the update rule of any appropriate gradient descent optimization algorithm, e.g., RMSprop or Adam, to update the parameter values of the dual encoder model 110.

The system 100 can also train the correction model 130, using a drift loss function 155 that measures the drift 162 between the corrected target embeddings 132 and the respective current target embeddings 140 generated for the relevant target data items 134 by the target encoder model 112 at the particular training iteration. More specifically, training on the drift loss function 155 ensures that the correction model 130 can learn to predict an accurate corrected target embedding for each of the target data items 102 to correct for the stale embeddings at each training iteration.

As an example, the drift loss function 155 can be a measure of a divergence, e.g., a Kullback-Leibler divergence or a measure cross-entropy, between the truncated softmax distribution generated from the current target embeddings 140 and the corrected softmax distribution generated from the corrected target embeddings 132. In particular, the system 100 can compute parameter updates 175 for the corrector model 130 by calculating and backpropagating gradients of the drift loss function 155, e.g., using the update rule of any appropriate gradient descent optimization algorithm, e.g., RMSprop or Adam, to update the parameter values of the corrector model 160.

In some cases, the system 100 can train the dual encoder model 110 using the loss function 160 and the drift loss function 155. In particular, in some cases, the system 100 can jointly train the dual encoder model 110 and the correction model 130. In this case, the system 100 can train both the dual encoder 110 and the corrector model 130 at each of a number of training iterations to minimize the discrepancy between the corrected approximated softmax, as determined using the corrected target embeddings 140 and the actual truncated softmax, as determined for the identified relevant subset of target data items 134.

For example, the system 100 can be used to train a retrieval augmented generative machine learning model. In particular, the dual encoder model 110 can be a retriever model that is used to identify relevant items for further processing using a generative machine learning model. In some cases, the generative machine learning model can be a language processing neural network. In this case, the retrieval augmented generative machine learning model is a retrieval augmented language model.

As an example, the input query data item can be a text prefix, e.g., a question, that is processed using the dual encoder model 110 to identify relevant documents in a corpus of documents that include content relevant to answering the question in the input query data item. After identifying the relevant documents using the dual encoder model 110, the generative machine learning model can process the identified documents to generate the response to the query data item. As another example, the input query data item can be an audio clip that is processed using the dual encoder model 110 to identify relevant images in a corpus of images that include content relevant to responding to the query data item. After identifying the relevant images, the generative machine learning model can process the identified images to generate the response to the query data item.

Generally, when training a retrieval augmented generative machine learning model, the system 100 can receive question-answer pairs that can be used for training the dual encoder 110, e.g., instead of the target label(s) 162 for the query data item(s) 104 (as depicted in FIG. 1). In particular, the system 100 can train the dual encoder 110 based on an indication of the extent to which the generative machine learning model generated the correct answer, e.g., in accordance with the corresponding answer provided in the question-answer pair, when conditioned on the given retrieved target items that were selected for processing using the generative machine learning model.

As an example, in the case that the system 100 is used to train a retrieval augmented language model, the system 100 can use perplexity distillation, as is described in more detail in Izacard, G., et. al., “Few-shot learning with retrieval augmented language models (arXiv:2208.03299, 2022), to generate a normalized probability distribution that represents likelihood scores of the responses generated using the language model conditioned on the identified target data items. In this case, the system 100 can use the normalized probability distribution to train the dual encoder model 110.

FIG. 2 illustrates the concept of accuracy drift of target embeddings in panel 200.

Panel 200 is a projection of the target embeddings from a higher-dimensional space to a two-dimensional plane. In panel 200, the stale embeddings 220 are depicted as solid points, the corrected embeddings 230 are depicted as points filled with lines, and the true target embeddings 210 are depicted as points filled with a hatching pattern. In this case, the true target embeddings 210 were generated for each of the target embeddings shown, e.g., by processing the corresponding target data items using the target encoder model.

In particular, panel 200 demonstrates how an example target embedding correction training system, e.g., the example target embedding correction training system 100 of FIG. 1, can correct the position of the stale target embeddings to be closer to the true target embeddings in the embedding space. More specifically, the discrepancy between the true target embeddings 210 and the cached target embeddings 220 is the accuracy drift that occurs as the cached target embeddings become increasing stale. While projecting from a higher-dimensional space to a two-dimensional plane can distort distances and is merely a representation of the relative positioning target embeddings, it is clear that the corrected embeddings 230 appear closer to the true targets 210 than the stale embeddings 220.

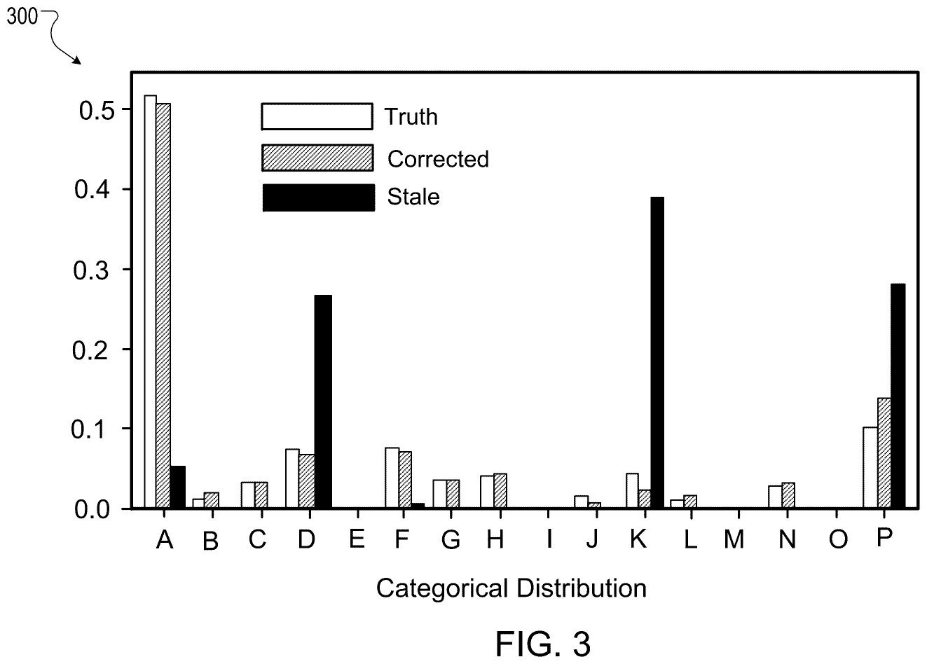

FIG. 3 depicts results that demonstrate the effectiveness of correcting target embeddings, e.g., using the target embedding correction training system of FIG. 1.

The plot 300 demonstrates the categorical softmax distribution for a toy problem involving target embeddings. The categorical softmax distribution includes the probability masses assigned to each of the outcomes. In the particular example depicted, the target data items A-P are represented as target embeddings distributed around a unit circle and the plot 300 depicts the probability mass assigned to each target data item A-P according to the categorical softmax distribution calculated using the target embeddings for the respective target data items.

More specifically, the plot illustrates how the continued use of stale embeddings can result in incorrect outputs from a dual encoder model, e.g., as is highlighted from the difference between the probability mass assigned to the true target embeddings for target data items A, D, K, and P. In particular, the stale embeddings result in a gross underestimate of the probability mass for target data item A and a gross overestimate of the probability mass for target data items D, K, and P. Notably, the corrected embeddings result in a fairly similar probability mass for all target data items considered in the toy experiment thereby further underscoring the benefits of correcting for stale embeddings using a corrector model.

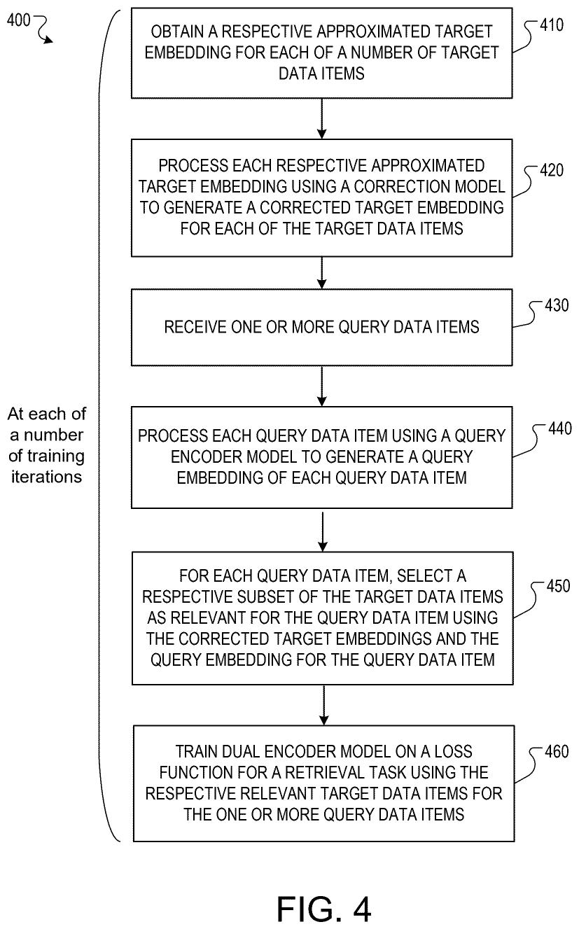

FIG. 4 is a flow diagram of an example process for using a correction model to train a dual encoder model. For convenience, the process 400 will be described as being performed by a system of one or more computers located in one or more locations. For example, a target embedding correction training system, e.g., the target embedding correction training system 100 of FIG. 1, appropriately programmed in accordance with this specification, can perform the process 400 to train a dual encoder that includes a query encoder model and a target encoder model to perform a retrieval task.

In particular, the system can repeat the process 400 at each of a number of training steps to train the dual encoder to perform a retrieval task. In this case, a retrieval task refers to selecting one or more of the target data item(s) 102 as relevant for each respective query data item. For example the retrieval task can be a question-answering task, e.g., in which the dual encoder identifies one or more relevant documents for a query that include information relevant to answering the query. In some cases, the query encoder model and the target encoder model can be implemented as language processing neural networks. For example, either or both of the query encoder model and the target encoder model can be implemented as large language models.

The system can obtain a respective approximated target embedding for each of a number of target data items (step 410). As an example, the target data items can be one or more of documents, images, or videos. In particular, the system can perform the retrieval task by selecting a subset of the target data items as relevant for a particular query data item, as will be described in more detail below.

For example, the system can obtain the respective approximated target embeddings from a maintained buffer that includes buffer data that specifies the respective approximated target embeddings for each of the plurality of target data items. In some cases, the system can generate the buffer data, e.g., by processing each of the number of target data items using the target encoder model at a first training iteration, e.g., a particular training iteration, to generate the buffer data. In some cases, the system can update the buffer data using the current embeddings of the relevant target data items, e.g., at each training iteration or every N training iterations.

The system can process each respective approximated target embedding using a correction model to generate a corrected target embedding for each of the target data items (step 420). In particular, the system can process the respective approximated target embedding for each target data item using the correction model to generate the corrected target embedding for the target data item. As an example, the correction model can be a small model, e.g., with fewer parameters, a less complicated neural network architecture, or both with respect to the dual encoder model.

More specifically, the system can be configured such that the buffer data and the corrected target embeddings fit within the memory of training hardware that is used to perform the training method. In some cases, the number of target data items is a sufficiently large number of target data items, such that updating the target embeddings using the target encoder model at each training iteration is intractable within memory of training hardware performing the training method. Rather than updating the target embeddings at each training iteration, the system can use the correction model to overcome performance drift and correct the target embeddings for each target data item.

The system can receive one or more query data items (step 430). As an example, each query data item can be text. As another example, each query data item can be an image or a video. In some cases, the query data item is a text input or an input image and the retrieval task involves identifying one or more relevant documents as target data items for the input text or input image. In another case, the query data item is a text input, and the retrieval task involves identifying one or more relevant images or videos for the query data item. In yet another case, the query data item is an image or a video, and the retrieval task involves identifying one or more image or videos as the target data items.

The system can then process each query data item using a query encoder model to generate a query embedding of each query data item (step 440). The system can then select a respective subset of the target data items as relevant for each query data item using the corrected target embeddings and the query embedding for the query data item (step 450). In particular, the system can select the subset of the target data items by identifying the target data items associated with a subset of k most similar corrected target embeddings with respect to the embedding of the query data item as the relevant target data items. For example, the system can determine a respective measure of probability mass for each of the target data items by computing a measure of similarity between the corrected target embedding for the target data item and the query embedding to generate an unnormalized logit value. The system can then determine the target data items with the k highest measures of probability mass as the relevant target data items. In some cases, the system can apply noise to the unnormalized logit values for each of the target data items to generate noisy unnormalized logit values. In this case, the system can determine the relevant target data items based on a top k measure of probability mass for the noisy unnormalized logit values.

The system can train the dual encoder model on a loss function for the retrieval task using the respective relevant target data items for the one or more query data items (step 460). In particular, for each query data item, the system can process each of the relevant target data items using the target encoder model to generate a current target embedding of each of the relevant target data items. The system can then compute a similarity measure between the query embedding and the current target embedding of the relevant target data item for each relevant target data item, and can train the dual encoder model using the similarity measures for the relevant target data items. For example, the system can obtain a corresponding target label for each query data item and can determine a respective unnormalized logit value for each of the relevant target data items for each query data item using the similarity measure of the query data item and each current target embedding. The system can then evaluate a softmax distribution using the unnormalized logit values to determine a predicted target label and can determine a loss between the predicted target label and the corresponding target label for each query data item.

In the case that the dual encoder model includes a language processing neural network, e.g., that either or both of the query encoder model or the target encoder model are implemented as a language processing neural network, the system can generate a perplexity for a ground truth response to each query data item and can train the dual encoder model using the perplexities. In particular, the system can process each query data item and each relevant target data item for the query data item using a language processing neural network, e.g., a different language processing neural network, to generate a perplexity for the relevant target data item that quantifies the measure of uncertainty in the selection of the relevant target data items. In this case, the system can generate a target distribution using the perplexities for each query data item, and can train the dual encoder model on a loss that measures, for each query item, a difference between the target distribution and a distribution over the subset of relevant target data items generated using the current target embeddings, e.g., of the current iteration. In some cases, the system can additionally train the language processing neural network using the loss.

The system can also train the correction model using the corrected target embeddings and the current target embeddings for the relevant target data items for each query data item. In this case, the system can train the correction model on a drift loss function that measures a discrepancy between the corrected target embeddings and the current target embeddings for each of the relevant target data items. As an example, the drift loss function can include a mean-square error loss for each query data item, e.g., calculated between the corrected target embedding and the respective current target embedding for each relevant target data item.

As another example, for each query data item, the system can compute a respective current unnormalized logit value for each of the relevant target data items using the similarity measure of the query embedding and each current target embedding, and the system can compute a respective corrected unnormalized logit value for each of the relevant target data items using the similarity measure of the query embedding and each corrected target embedding. In this case, the drift loss function provides a measure of a divergence, e.g., a Kullback-Leibler divergence or a cross-entropy loss, between a probability distribution generated from the current unnormalized logit values and a second probability distribution generated from the corrected unnormalized logit values for each query data item.

More specifically, the system can train the dual encoder, the corrector model, or both by training the model(s) at each of a number of training iterations until a training termination criterion is met. In particular, the dual encoder, the corrector model, or both can be trained by calculating and backpropagating gradients of an objective function to update parameter values of the model(s), e.g., using the update rule of any appropriate gradient descent optimization algorithm, e.g., RMSprop or Adam.

In some cases, the dual encoder and the corrector model are jointly trained, e.g., using the respective approximated target embeddings of the target data items generated by the dual encoder at each training iteration. In particular, the corrector model can receive training data that includes the approximated target embeddings at each training iteration and does not require additional data generated with any additional computational resources.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for training a dual encoder model comprising a query encoder model and a target encoder model to perform a retrieval task, the method comprising:
at each of a plurality of training steps:
obtaining a respective approximated target embedding for each of a plurality of target data items;
for each target data item, processing the respective approximated target embedding of the target data item using a correction model to generate a corrected target embedding of the target data item;
receiving one or more query data items;
for each query data item:
processing the query data item using the query encoder model to generate a query embedding of the query data item; and
selecting, using the corrected target embeddings of the target data items and the query embedding of the query data item, a subset of the target data items as relevant target data items; and
training the dual encoder model on a loss function for the retrieval task using the relevant target data items for the one or more query data items.

2. The method of claim 1, wherein training the dual encoder model on a loss function for the retrieval task using the relevant target data items for the one or more query data items comprises:
for each query data item:
processing each of the relevant target data items using the target encoder model to generate a respective current target embedding of each of the relevant target data items, and
for each relevant target data item, computing a similarity measure between the query embedding and the current target embedding of the relevant target data item; and
training the dual encoder model using the similarity measures for the relevant target data items.

3. The method of claim 2, further comprising, at each of the plurality of training steps:
training the correction model using, for each query data item, the corrected target embeddings and the current target embeddings for the relevant target data items.

4. The method of claim 3, wherein training the correction model comprises:
training the correction model on a drift loss function that measures a discrepancy between the corrected target embeddings and the respective current target embeddings for each of the relevant target data items.

5. The method of claim 4, wherein training the correction model on the drift loss function comprises:
for each query data item:
computing a respective current unnormalized logit value for each of the relevant target data items using the similarity measure of the query embedding and each current target embedding; and
computing a respective corrected unnormalized logit value for each of the relevant target data items using the similarity measure of the query embedding and each corrected target embedding; and
wherein the drift loss function measures, for each query data item, a measure of a divergence between a first probability distribution generated from the current unnormalized logit values and a second probability distribution generated from the corrected unnormalized logit values.

6. The method of claim 4, wherein the drift loss function comprises, for each query data item, a mean-square error loss between, for each relevant target data item, the corrected target embedding and the respective current target embedding.

7. The method of claim 1, wherein selecting the subset of the target data items as relevant target data items comprises:
identifying target data items associated with a subset of k most similar corrected target embeddings with respect to the embedding of the query data item as the relevant target data items.

8. The method of claim 7, wherein identifying the target data items associated with the subset of k most similar corrected target embeddings with respect to the embedding of the query data item further comprises:
determining a respective measure of probability mass for each of the target data items, comprising computing a measure of similarity between the corrected target embedding for the target data item and the query embedding to generate an unnormalized logit value; and
determining the target data items associated with the k highest measures of probability mass as the relevant target data items.

9. The method of claim 8, further comprising:
applying noise to the unnormalized logit values to generate noisy unnormalized logit values; and
determining the target data items associated with the k highest measures of probability mass based on the noisy unnormalized logit values as the relevant target data items.

10. The method of claim 1, wherein obtaining the respective approximated target embeddings comprises:
obtaining the respective approximated target embeddings from a maintained buffer comprising buffer data, wherein the buffer data specifies the respective approximated target embeddings for each of the plurality of target data items.

11. The method of claim 10, further comprising processing each of the plurality of target data items using the target encoder model at a first training iteration to generate the buffer data.

12. The method of claim 10, further comprising, at each of the plurality of training iterations:
for each query data item, processing each of the relevant target data items using the target encoder model to generate a respective current target embedding of each of the relevant target data items; and
updating the buffer data using the current target embeddings of the relevant target data items.

13. The method of claim 12, wherein at each of the plurality of training steps, the buffer data and the corrected target embeddings fit within memory of training hardware performing the training method.

14. The method of claim 2, wherein training the dual encoder model using the similarity measures comprises, for each query data item:
obtaining a corresponding target label for the query data item;
determining a respective unnormalized logit value for each of the relevant target data items using the similarity measure of the query data item and each current target embedding;
evaluating a softmax distribution using the unnormalized logit values to determine a predicted target label; and
determining a loss between the predicted target label and the corresponding target label.

15. The method of claim 2, wherein training the dual encoder model comprises, for each query data item:
for each relevant target data item, processing the query data item and the relevant target data item using a language model neural network to generate a perplexity for a ground truth response to the query data item; and
training the dual encoder model using the perplexities.

16. The method of claim 15, wherein training the dual encoder model further comprises:
for each query data item, generating a target distribution using the perplexities; and
training the dual encoder model on a loss that measures, for each query data item, a difference between the target distribution and a distribution over the subset of relevant target data items generated using the current target embeddings.

17. The method of claim 1, wherein the plurality of target data items comprises a sufficiently large number of target data items such that updating the target embeddings using the target encoder model at each training iteration is intractable within memory of training hardware performing the training method.

18. The method of claim 1, wherein the dual encoder and the corrector model are jointly trained, and wherein the corrector model receives training data comprising the respective approximated target embeddings of the target data items generated by the dual encoder at each training iteration and does not require additional data generated with additional computational resources.

19. A system comprising one or more computers and one or more storage devices storing instructions that are operable, when executed by the one or more computers, to cause the one or more computers to perform operations comprising:
at each of a plurality of training steps:
obtaining a respective approximated target embedding for each of a plurality of target data items;
for each target data item, processing the respective approximated target embedding of the target data item using a correction model to generate a corrected target embedding of the target data item;
receiving one or more query data items;
for each query data item:
processing the query data item using the query encoder model to generate a query embedding of the query data item; and
selecting, using the corrected target embeddings of the target data items and the query embedding of the query data item, a subset of the target data items as relevant target data items; and
training the dual encoder model on a loss function for the retrieval task using the relevant target data items for the one or more query data items.

20. A computer storage medium encoded with a computer program, the program comprising instructions that are operable, when executed by data processing apparatus, to cause the data processing apparatus to perform operations comprising:
at each of a plurality of training steps:
obtaining a respective approximated target embedding for each of a plurality of target data items;
for each target data item, processing the respective approximated target embedding of the target data item using a correction model to generate a corrected target embedding of the target data item;
receiving one or more query data items;
for each query data item:
processing the query data item using the query encoder model to generate a query embedding of the query data item; and
selecting, using the corrected target embeddings of the target data items and the query embedding of the query data item, a subset of the target data items as relevant target data items; and
training the dual encoder model on a loss function for the retrieval task using the relevant target data items for the one or more query data items.
